(19) United States
(12) Patent Application Publication
(10) Pub. No.: US 2019/0003476 A1
(43) Pub. Date: Jan. 3, 2019

(54) HALOGEN SATURATED SYNTHETIC FLUID IN ELECTRIC SUBMERSIBLE PUMP SYSTEMS

(71) Applicants: You Cheng JEE, Singapore (SG); Alejandro CAMACHO CARDENAS, Houston, TX (US)

(72) Inventors: You Cheng JEE, Singapore (SG); Alejandro CAMACHO CARDENAS, Houston, TX (US)

(21) Appl. No.: 15/737,772

(22) PCT Filed: Jun. 19, 2015
(86) PCT No.: PCT/US2015/036685

§ 371 Date: Dec. 19, 2017

(51) Int. Cl. F04B 53/18; E21B 43/12; F04B 47/06; H02K 7/14; H02K 5/132

(52) U.S. Cl. CPC F04B 53/18; E21B 43/128; H02K 5/132; H02K 7/14; F04B 47/06

(57) ABSTRACT

An electric submersible pump (ESP) system having a motor and motor protector containing a halogen saturated synthetic fluid that is chemically inert and non-flammable, such as a polychlorotrifluoroethylene fluid.

### BACKGROUND

This section provides background information to facilitate a better understanding of the various aspects of the disclosure. It should be understood that the statements in this section of this document are to be read in this light, and not as admissions of prior art.

When producing fluids from subterranean locations, a submersible pumping system, such as an electric submersible pump (ESP) system, can be used to lift fluids from a well. In addition to a pump section, ESP systems can include various components, such as a motor and a motor protector. The motor provides power to the ESP. The protector is coupled to the motor to allow for pressure equalization between the interior of the motor and the exterior. For example, if the system is utilized deep within a wellbore, the pressure acting on the interior of the motor must be allowed to substantially equalize with the increasing external pressure incurred as the system is moved deeper into the wellbore. Conventional motor protectors utilize labyrinths, isolation chambers, expandable bags, and other types of barriers that permit equalization of pressure without allowing external fluid to move into the motor. Thus, the motor is allowed to undergo pressure equalization without contamination of its internal lubricating oil. The protector also supports axial thrust loads developed by the pump.

Over time, operation of the ESP can become compromised for various reasons such as thermal cycling, mechanical seal failures, and wear or scale that can result in a malfunction of the protector. Once a malfunction occurs, wellbore fluid can breach into chambers of the protector, mix with the clean lubricating fluid contained in the protector, and eventually enter into the motor. Contamination of the clean lubricating fluid inside the motor leads to short circuit, which is one of the most common failure modes in ESP motors.

### SUMMARY

According to one or more aspects, systems and methods of protecting electric submersible pumping (ESP) systems include filling a motor protector and a motor with a halogen saturated synthetic fluid, such as a polychlorotrifluoroethylene fluid, to act as a lubricant.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates a pumping system deployed in a wellbore according to one or more aspects of the disclosure.

FIG. 2 is a partial cross-sectional view of a motor protector according to one or more aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed.

As used herein, the terms connect, connection, connected, in connection with, and connecting may be used to mean in direct connection with or in connection with via one or more elements. Similarly, the terms couple, coupling, coupled, coupled together, and coupled with may be used to mean directly coupled together or coupled together via one or more elements. Terms such as up, down, top and bottom and other like terms indicating relative positions to a given point or element are may be utilized to more clearly describe some elements. Commonly, these terms relate to a reference point such as the surface from which drilling operations are initiated.

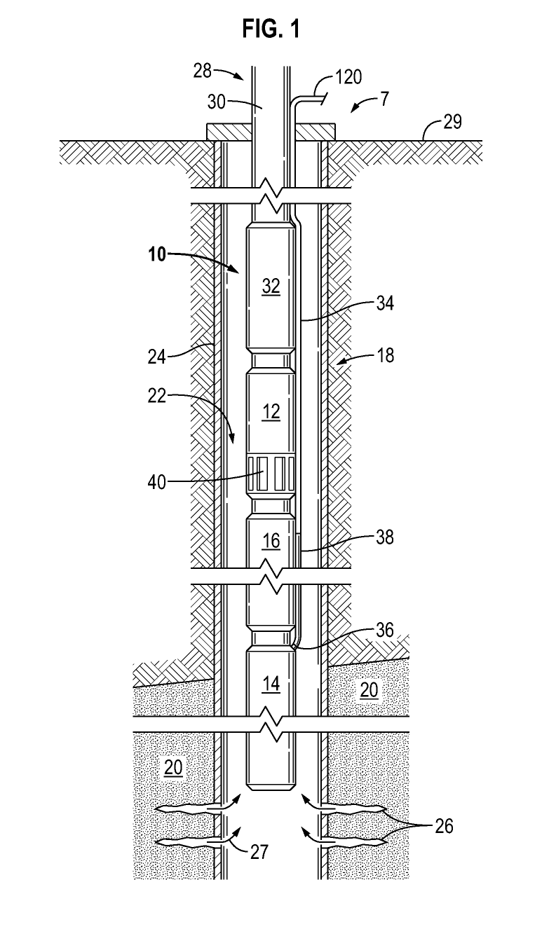

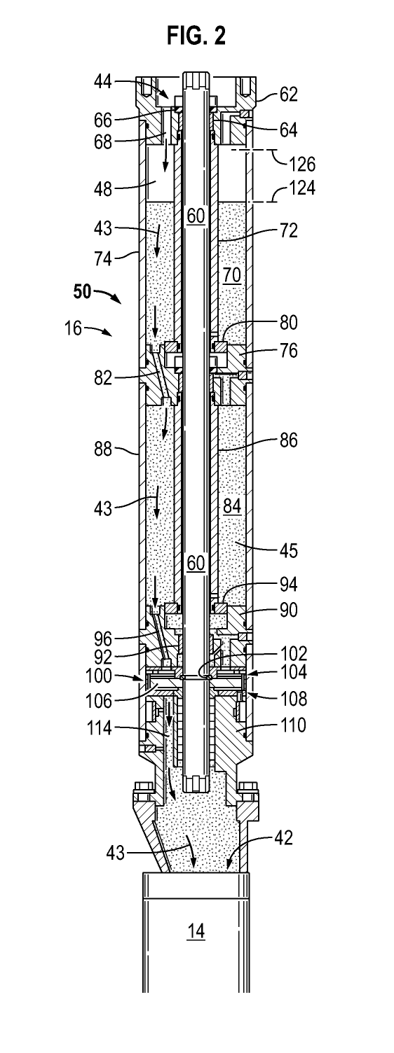

FIG. 1 illustrates a well system 7 incorporating a pumping system, generally denoted by the numeral 10. Pumping system 10 is illustrated deployed in a wellbore 22 in accordance with one or more aspects of the disclosure. Pumping system 10 comprises a submersible pump 12, a submersible motor 14, and a motor protector 16. A more detailed view of the motor protector 16 according to one or more aspects is provided in FIG. 2. Pumping system 10 is designed for deployment in a well 18 within a geological formation 20 containing desirable production fluids 27, such as petroleum. A wellbore 22 includes a wellbore casing 24. Wellbore casing 24 may comprise perforations 26 through which production fluid 27 flows into wellbore 22 from the geological formation 20. Pumping system 10 is deployed in wellbore 22 by a deployment system 28 that may have a variety of configurations. For example, deployment system 28 may comprise tubing 30 connected to submersible pumping system 10 by a connector 32.

Power is provided to the submersible motor 14 via a power cable 34 which is coupled to submersible motor 14 by a power cable connector 36. Connector 36 has an isolation tube 38 extending generally along the exterior of motor protector 16 towards an upper region of the protector. Once powered, the submersible motor 14 drives the submersible pump 12, which draws production fluid 27 into wellbore 22 and through a pump intake 40. The submersible pump 12 then produces the production fluid 27 to a desired location, e.g. earth surface 29, via tubing 30.

Refer now to FIGS. 1 and 2, where FIG. 2 illustrates a partial cross-sectional view of a motor protection system 50. Motor protector 16 and submersible motor 14 are filled to a desired level with a lubricating fluid 45 that may freely flow downward along a flow path 43 through motor protector 16 and into an interior 42 of submersible motor 14. The submersible motor 14 and the motor protector 16 may be filled with lubricating fluid 45 by pouring the desired liquid into an upper region 44 of motor protector 16.

Flow path 43 also may be continued through power cable connector 36 and its isolation tube 38. Thus, if lubricating fluid 45 is poured into upper region 44 of motor protector 16, the lubricating fluid 45 is free to move downwardly through motor protector 16 into interior 42 of submersible motor 14 and ultimately upwardly through power cable connector 36 and its isolation tube 38 until the fluid level in motor protector 16 and isolation tube 38 reaches a substantially equal level. Accordingly, it is not necessary to seal power cable 34 to submersible motor 14 as it enters submersible motor 14.

The motor protection system 50 comprises the motor protector 16 that is coupled to submersible motor 14 via a motor protector mounting end 52 that is attached to a motor coupling end 54. The motor protector 16 comprises a shaft 60 that is coupled to a corresponding shaft of the submersible motor 14. Shaft 60 is rotatably mounted in an upper protector head 62 via an upper bushing 64. A shaft seal 66 prevents particulates and other solids from moving downwardly along shaft 60. A vent port 68 extends between upper region 44 and an upper gravity chamber 70. Upper region 44 is exposed to the environment surrounding motor protector 16 via appropriate ports or openings as with a conventional motor protector. Upper gravity chamber 70 is formed as an annular space between an upper shaft tube 72 and an upper housing 74 that forms an outer wall of motor protector 16.

Upper housing 74 is attached to the upper protector head 62 by, for example, threaded engagement and/or an appropriate weldment. The upper housing 74 is similarly coupled at a lower end to a protector upper body 76 by, for example, appropriate threaded and/or welded engagement.

Protector upper body 76 rotatably receives shaft 60 and supports the shaft 60 via an internal bushing 78. Additionally, a shaft tube support disc 80 is positioned to couple upper shaft tube 72 to protector upper body 76. A communication channel 82 extends generally longitudinally through protector upper body 76 to permit fluid flow through protector upper body 76 between upper gravity chamber 70 and a lower gravity chamber 84.

Lower gravity chamber 84 generally comprises an annular chamber defined between a lower shaft tube 86 and an outlying lower isolation chamber housing 88. As described above with respect to upper housing 74, lower isolation chamber housing 88 is connected to protector upper body 76 and extends downwardly to a lower support body 90. Lower isolation housing 88 is connected to lower support body 90 by, for example, an appropriate threaded and/or welded connection.

Lower support body 90 rotatably receives shaft 60 and supports rotation of the shaft via a bushing 92. Additionally, a lower shaft tube support disc 94 couples lower shaft tube 86 to an upper portion of lower support body 90, as illustrated. Lower support body 90 also comprises a generally longitudinal communication channel 96 that allows the free flow of liquid therethrough. A breather-stand tube may be coupled to lower support body 90 in fluid communication with communication channel 96 and extending upwardly therefrom. The breather tube inhibits the ability of particulate matter to migrate through lower support body 90 to lower components. Thus, if sand or other particulate matter manages to move into lower gravity chamber 84, the particulates tend to collect along the upper surface of lower support body 90 instead of passing through communication channel 96.

In the embodiment illustrated, a thrust bearing system 100 is disposed below lower support body 90. According to one exemplary embodiment, thrust bearing system 100 comprises a thrust bearing locking ring 102 positioned between lower support body 90 and an upthrust bearing 104. A thrust bearing runner 106 is disposed below upthrust bearing 104, and a downthrust bearing 108 is disposed between thrust bearing runner 106 and a lower protector base 110. Thrust bearing system 100 can be any of a variety of thrust bearing types that are commonly used in submersible pumping components.

Lower protector base 110 rotatably receives shaft 60 and supports the shaft 60 via a bushing 112. Additionally, a communication channel 114 extends through lower protector base 110 from thrust bearing system 100 to motor protector mounting end 52. Communication channel 114 permits the flow of internal liquid into interior 42 of submersible motor 14. It should be noted that the flow of liquid is not restricted through thrust bearing system 100, so liquid is permitted to freely flow from communication channel 96 through thrust bearing system 100 and then downwardly into submersible motor 14 via communication channel 114. Thus, a free flow passage is formed from upper region 44 of motor protector 16 through vent port 68, upper gravity chamber 70, communication channel 82, lower gravity chamber 84, communication channel 96, thrust bearing system 100 and communication channel 114 to interior 42 of submersible motor 14.

Depending on the specific design of motor protection system 50, the free flow of lubricating fluid 45 may be allowed to continue through power cable connector 36 and its isolation tube 38. Isolation tube 38 includes an upper open end or port 120 that permits direct communication between the interior of isolation tube 38 and the environmental fluid that surrounds submersible motor 14 and motor protector 16.

To prevent potentially deleterious environmental fluids from reaching interior 42 of submersible motor 14, motor protection system 50 is filled to an operational level 124 with the lubricating fluid 45. The lubricating fluid 45 is selected for its ability to prevent migration of environmental fluid, such as production fluid 27, through motor protector 16 and/or power cable connector 36 to the interior of submersible motor 14. Otherwise, the wellbore fluids could cause excessive wear and other to damage internal components of the motor.

Lubricating fluid 45 may be selected for its lack of affinity with the surrounding environmental fluids. Motor protection system 50 is shown utilized in a wellbore environment for the production of oil-based fluids. Accordingly, lubricating fluid 45 may be selected for its inability or limited ability to mix with oil-based fluids. Additionally, lubricating fluid 45 typically is selected with a greater specific gravity than the surrounding fluids. For example, wellbore fluids may have a specific gravity of approximately 0.8 or less. Accordingly, lubricating fluid 45 is selected such that its specific gravity is greater than approximately 1.0, and for many applications the specific gravity is greater than approximately 1.5. Thus, lubricating fluid 45 is substantially heavier than the surrounding environmental fluids, and the surrounding environmental fluids are unable to move downwardly through isolation tube 38 or motor protector 16 to submersible motor 14.

In accordance with one aspect, the lubricating fluid 45 may be a polychlorotrifluoroethylene (PCTFE)-based liquid. PCTFE liquids are halogen saturated synthetic lubricants that are chemically inert and non-flammable. Chlorotrifluoroethylene (CTFE) is a chlorofluorocarbon having the chemical formula CF₂CCIF. CTFE has a carbon-carbon double bond and can be polymerized to form PCTFE. Chemically, PCTFE liquids and waxes are saturated low molecular weight polymers of chlorotrifluoroethylene. Additives, such as a hydrocarbon rust inhibitor, can be added to PCTFE liquids. PCTFE liquids are commercially available from manufacturers such as Halocarbon Products Corporation and Gabriel Performance Products.

As compared to conventional lubricants such as mineral and polyalphaolefin (PAO) oils, PCTFE liquids have several benefits. PCTFE is non-reactive with chemicals typically encountered in wellbores. PCTFE oils are inert because the carbon chain, the backbone of the molecule, is completely halogenated. On the other hand, hydrocarbon oils contain a significant number of hydrogen atoms which react readily with aggressive chemicals. Among the list of chemicals that will not react with PCTFE oils are: ammonium perchlorate, hydrogen sulfide, boron trichloride, muriatic acid, boron trifluoride, nitrogen oxides (all), bromine, nitrogen trifluoride, bromine trifluoride (gaseous), oleum, carbon dioxide, oxygen (liquid and gaseous), calcium hypochlorite, ozone, chlorinated cyanurates, sodium chlorate, chlorine, sodium hypochlorite, chlorine dioxide, sulfur hexafluoride, chlorine trifluoride (gaseous), sulfur trioxide, fluorine (gaseous), sulfuric acid, fuming nitric acid, thionyl chloride, hydrogen fluoride, uranium hexafluoride, hydrogen peroxide.

The bond energy of carbon with fluorine is higher than the bond energy of carbon with hydrogen, which causes PCTFE oil to break down less than conventional lubricants at high temperatures.

PCTFE liquids can have surface tension values of around 23 to 30 dynes/cm, resulting in easy wetting and good lubricity of most materials. Steel parts that have been lubricated with PCTFE liquids and then disassembled for inspection appear to have benefited from PCTFE lubrication, even in severe service.

PCTFE liquids are not soluble in aqueous acidic, alkaline, or neutral solutions. Therefore, water that comes into contact with PCTFE liquids is more likely to separate out.

PCTFE liquids can have a specific gravity of approximately 2, which is higher than water and most wellbore fluids. As a result, separated water/wellbore fluid will stay on top of the PCTFE liquid layer in the protector and water ingress into ESP motor is prevented. Compared to conventional oil, which may have a specific gravity <1, the water/wellbore fluid will sink to the bottom of the protector chamber and work its way into the motor.

Unused PCTFE liquids exhibit dielectric properties that are equivalent or better than conventional oil. PCTFE liquids resist aging and resist water absorption. Therefore, dielectric properties of used or “aged” PCTFE oil is expected to be better than conventional PAO oil.

Extreme-pressure tests using the four-ball method show that PCTFE liquids exhibit no seizure even at a final applied load of 800 kg. PCTFE liquids also show load wear indexes that are appreciably better than conventional hydrocarbon-based oils.

With proper usage and maintenance, PCTFE oils can be restored to almost their original properties. They may not have to be disposed of or incinerated. In the long run this reduces lubrication costs.

PCTFE liquids having a bulk modulus of well over 200,000 psi at 100° F. (37.8° C.) with applied pressures up to 10,000 psig are available. PCTFE liquids have compressibilities similar to mineral oils and they are much less compressible than polytetrafluoroethylene (PTFE) based lubricants. Low compressibility results in a lesser volume reduction as compared to PTFE lubricants under high wellbore pressure, and a faster and more accurate hydraulic response.

PCTFE liquids have lower thermal expansion coefficient as compared to PTFE based lubricants. A lower thermal expansion coefficient results in less oil loss from the ESP protector and motor under high temperature, which is of advantage for longer ESP runlife. In addition, PCTFE liquids have a thermal conductivity that is approximately 2 times higher than that of PTFE based lubricants, which helps remove heat from the motor.

Based on all the above advantageous properties, embodiments of the invention include methods and systems that use PCTFE oils to enhance the performance and runlife of ESP in the following aspects. With high chemical inertness, high thermal stability, low surface tension, good lubricity, insolubility and immiscibility, better dielectric properties and high shear/extreme pressure/load carrying capacity, PCTFE oils when used in ESP motor and protector will help to extend the useful life of ESPs in either vertical or horizontal installations. Due to their high density and immiscibility with water/wellbore fluids, PCTFE oils can be used as effective fluid barrier in ESP motors and protectors in relatively vertical wells. Leveraging on the effect of gravity separation, wellbore fluid entering the ESP protector will always remain on top of this fluid barrier. Thus, fluid ingress is more difficult. This aspect of the PCTFE oils may eliminate the need for components such as labyrinth tube chambers, positive seal (bags/bellows), and/or pressure relief valve. The straight gravity chambers (filled with PCTFE oils all the way down to motor) offer a much simpler and robust construction of ESP protector. Positive seals (bags/bellows) are not required unless for non-vertical well, gas and redundancy reasons. This aspect of the invention also may not rely on shaft seals for leakage prevention. Shaft seals are required for handling sand and particles.

According to one or more aspects, lubricating fluid 45 is poured into upper region 44 of motor protector 16 and the liquid flows downwardly through motor protector 16. The lubricating fluid 45 fills interior 42 of submersible motor 14 and rises through power cable connector 36 until the system is filled to a desired level, labeled with reference numeral 124 in FIG. 2. According to some aspects, the remainder of motor protector 16 and the isolation tube 38 may be filled with a less expensive, sacrificial liquid that is typically lost during deployment and initial startup of the system. However, lubricating fluid 45 also could be used to fill motor protector 16 and the isolation tube 38 to a higher level. Once motor protector 16 is filled to desired level 124, the remaining components of electric submersible pumping system 10 are connected and the submersible pumping system 10 is deployed to a desired location within wellbore 22.

Both the natural heat of the subterranean location and the heating of motor during initial operation cause lubricating fluid 45 to heat up and expand. As heat is generated while the submersible motor 14 is in operation, the lubricating fluid 45 from interior 42 of submersible motor 14 expands. As the lubricating fluid 45 expands, additional lubricating fluid 45 enters the motor protector 16 via the oil communication channel 114 and causes the level of the lubricating fluid 45 within the motor protector 16 to rise to a new level, labeled 126 in FIG. 2. When the level of the lubricating fluid 45 rises, some fluid 48 is discharged into the wellbore via the remaining portion of the flow path 43. If the motor protector 16 includes a layer of sacrificial fluid, the discharged fluid 48 may be the sacrificial fluid. If no sacrificial fluid is used, the discharged fluid may be a portion of the lubricating fluid 45. Allowing the fluid level to rise allows the pressure inside the submersible motor 14 and the motor protector 16 to equalize.

When the submersible motor 14 is shut down, the lubricating fluid 45 inside the submersible motor 14 will cool and contract. As the lubricating fluid 45 contracts, whatever fluid is in proximity to upper region 44 is drawn into the motor protector 16 via the flow path 43. The fluid that is drawn in could be production fluid 27, lubricating fluid 45, various other fluids that are encountered in wellbores, or a combination of these fluids. However, because the lubricating fluid 45 is much denser than and immiscible with the wellbore fluids, the wellbore fluids will tend to remain as a layer on top of the lubricating fluid 45 inside the upper gravity chamber 70 as shown in FIG. 2. When the submersible motor 14 heats up again, the level of the lubricating fluid 45 inside the upper gravity chamber 70 will rise. Similarly, when the submersible motor 14 cools again, the level of the lubricating fluid 45 falls. This thermal cycling will continue for the rest of the life cycle of the submersible pumping system 10.

The thermal conductivity of PCTFE is up to two times that of PTFE-based lubricants. As a result, heat will be dissipated from the submersible motor 14 much faster by the lubricating fluid 45 than a PTFE-based lubricant, which in turn helps reduce the temperature of the submersible motor 14. Additionally, due to the lower thermal expansion coefficient as compared to PTFE based lubricants, less lubricating fluid 45 will be expelled out to the wellbore during the thermal cycling. This will contribute to longer run life of submersible pumping system 10. The lubricating fluid 45 will also improve the performance and run life of the thrust bearing system 100 of the motor protector 16 due to its low surface tension, excellent lubricity, good shear, extreme pressure, and load carrying characteristics.

A method of protecting an ESP system is now described in reference to FIGS. 1-2. Protecting the ESP system begins with filling motor protector 16 and submersible motor 14 to a desired level with lubricating fluid 45, such as a halogen saturated synthetic fluid that is chemically inert and non-flammable. According to one aspect, lubricating fluid 45 is poured into upper region 44 of motor protector 16 and the lubricating fluid 45 flows downwardly through motor protector 16. The lubricating fluid 45 fills interior 42 of submersible motor 14 and rises through power cable connector 36 until the system is filled to desired level 124. According to some aspects, the remainder of motor protector 16 and the isolation tube 38 may be filled with a less expensive, sacrificial liquid that is typically lost during deployment and initial startup of the system. In another aspect, lubricating fluid 45 also could be used instead of the sacrificial liquid to fill motor protector 16 and the isolation tube 38 to a higher level. In another aspect, the lubricating fluid 45 is poured into the port 120, and the lubricating liquid flows through the power cable connector 36 to fill the submersible motor 14 and the motor protector 16. Once submersible motor 14 and motor protector 16 are filled to desired level 124, the submersible pumping system 10 is deployed to a desired location within wellbore 22.

Aspects of the forgoing relate to methods and systems of using PCTFE oil for lubricating and protecting ESP systems, with significant improvement in ESP run life and reliability. Although the present invention is described, with reference to FIGS. 1-2, utilized in a specific environment, this description should not be construed as limiting. The specific embodiment and environment illustrated and described is used to facilitate an understanding of the invention rather than to limit the invention. On the contrary, the intention is to cover all modifications, equivalents, and alternatives falling within the spirit and scope of the invention as defined by the appended claims. The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. An electrical submersible pumping system, comprising:
a pump;
a submersible motor;
a motor protector disposed between the submersible motor and the pump;
a halogen saturated synthetic fluid that is chemically inert and non-flammable disposed in one or more of the submersible motor and the motor protector; and
a fluid flow path communicating the halogen saturated synthetic fluid through one or more of the submersible motor and the motor protector.

2. The electrical submersible pumping system of claim 1, wherein the halogen saturated synthetic fluid is a polychlorotrifluoroethylene fluid.

3. The electrical submersible pumping system of claim 1, wherein the halogen saturated synthetic fluid has a specific gravity of approximately 2.0.

4. The electrical submersible pumping system of claim 1, wherein the halogen saturated synthetic fluid includes a rust inhibitor.

5. The electrical submersible pumping system of claim 1, wherein the halogen saturated synthetic fluid has a surface tension value between 23 and 30 dynes/cm.

6. The electrical submersible pumping system of claim 1, wherein the halogen saturated synthetic fluid has a bulk modulus of over 200,000 psi at 100° F. with an applied pressure of 10,000 psi.

7. The electrical submersible pumping system of claim 1, wherein the halogen saturated synthetic fluid has a coefficient of thermal expansion that is less than 0.001 (mm/mm·K).

8. The electrical submersible pumping system of claim 1, wherein the halogen saturated synthetic fluid has a thermal conductivity of approximately 0.2 (W/m·K).

9. A well system, comprising:
a pump system deployed in a wellbore having a submersible motor, a pump, and a motor protector disposed between the submersible motor and the pump;
a halogen saturated synthetic fluid that is chemically inert and non-flammable disposed in one or more of the submersible motor and the motor protector; and
a fluid flow path communicating the halogen saturated synthetic fluid through one or more of the submersible motor and the motor protector.

10. The well system of claim 9, wherein the halogen saturated synthetic fluid is a polychlorotrifluoroethylene fluid.

11. The well system of claim 9, wherein the halogen saturated synthetic fluid has a specific gravity of approximately 2.0.

12. A method, comprising pumping a well fluid from a wellbore in response to operating a pump that is submerged in the well fluid in the wellbore, the pump comprising an electric motor and a motor protector, wherein one or more of the motor and the motor protector contains a halogen saturated synthetic fluid.

13. The method of claim 12, further comprising communicating the halogen saturated synthetic fluid through one or more of the electric motor and the motor protector.

14. The method of claim 12, wherein the halogen saturated synthetic fluid is a polychlorotrifluoroethylene fluid.

15. The method of claim 12, wherein the halogen saturated synthetic fluid has a specific gravity of approximately 2.0.

16. The method of claim 12, wherein the halogen saturated synthetic fluid includes a rust inhibitor.

17. The method of claim 12, wherein the halogen saturated synthetic fluid has a surface tension value between 23 and 30 dynes/cm.

18. The method of claim 12, wherein the halogen saturated synthetic fluid has a bulk modulus of over 200,000 psi at 100° F. with an applied pressure of 10,000 psi.

19. The method of claim 12, wherein the halogen saturated synthetic fluid has a coefficient of thermal expansion that is less than 0.001 (mm/mm·K).

20. The method of claim 12, wherein the halogen saturated synthetic fluid has a thermal conductivity of approximately 0.2 (W/m·K).
